(19) United States
(12) Patent Application Publication
(10) Pub. No.: US 2011/0228323 A1
(43) Pub. Date: Sep. 22, 2011

(54) INFORMATION PROCESSING APPARATUS, METHOD FOR CONTROLLING INFORMATION PROCESSING APPARATUS, AND COMPUTER-READABLE STORAGE MEDIUM THAT STORES A PROGRAM

(75) Inventor: Keita Oshima, Tokyo (JP)

(73) Assignee: CANON KABUSHIKI KAISHA, Tokyo (JP)

(21) Appl. No.: 13/034,605

(22) Filed: Feb. 24, 2011

(30) Foreign Application Priority Data
Mar. 19, 2010 (JP) 2010-064912

(51) Int. Cl. G06F 3/12

(52) U.S. Cl. 358/1.15

(57) ABSTRACT

Information regarding paper feed stages of a printing apparatus is acquired, a determination is made of whether there are more types of paper to be used in printing of a print job than the number of paper feed stages of the printing apparatus. When determined that there are more types of paper than the number of paper feed stages of the printing apparatus, based on a condition predetermined such that values of a parameter are considered to be the same in a certain range, papers having parameter values considered to be the same are designated as one set. A collation job is generated for discharging to one discharge stage of the collation apparatus the one set designated from the plurality of types of paper that have been disposed in the respective paper feed stages of the collation apparatus, and the generated collation job is sent to the collation apparatus.

### BACKGROUND OF THE INVENTION

1. Field of the Invention

The present invention relates to an information processing apparatus that controls a print job, a method for controlling the information processing apparatus, and a computer-readable storage medium that stores a program.

2. Description of the Related Art

Among the types of printing using a POD system referred to as print-on-demand, there is printing of content that differs for each customer such as variable data printing, printing such as subset finishing, printing that handles a print job in which different types of paper are grouped, and so forth. Among these types of printing, for example, a case of printing a bill and an advertisement together as a set falls under the category of printing that handles a print job in which different types of paper are grouped. There are also cases such as hybrid workflows in which offset printing and POD are used together, and in such cases multiple types of paper are necessary, such as preprint paper in addition to plain paper.

Japanese Patent Laid-Open No. 11-198487 describes a method for selecting paper to be used in a print job from a plurality of types of paper. In Japanese Patent Laid-Open No. 11-198487, a page collation table is generated in a computer, and information related to each page of printed matter (page unit information) is stored in the page collation table. The page unit information includes a filename under which print content has been stored and a paper feed stage number of a paper feed stage that has been loaded with paper to be used for printing of that page. The computer, while referring to the generated page collation table, sends the print content and the paper feed stage number of each page to the printing apparatus.

Also, Japanese Patent Laid-Open No. 2005-216088 describes a configuration in which a plurality of types of paper are placed in a single paper feed stage, and a print job order is controlled according to the type and order of the placed paper.

However, the types of paper used when printing may sometimes exceed the number of paper feed stages. In Japanese Patent Laid-Open No. 11-198487, ordinarily one type of paper is placed in a single paper feed stage, so when a different type of paper than the paper placed in advance in the paper feed stages is required, it is necessary to substitute paper in a certain paper feed stage with the required paper. Accordingly, there is a large burden on a user, such as verification work when switching paper.

In Japanese Patent Laid-Open No. 2005-216088, a plurality of types of paper are stored in advance according to the print job order. However, such paper sorting must be performed by manual work, so ultimately there is a large burden on a user.

### SUMMARY OF THE INVENTION

An aspect of the present invention is to eliminate the above-mentioned problems with the conventional technology. The present invention provides an information processing apparatus that reduces a burden on a user when processing a print job that uses paper of more types than there are paper feed stages, a method for controlling the information processing apparatus, and a computer-readable storage medium that stores a program.

The present invention in its first aspect provides an information processing apparatus capable of connection to a collation apparatus capable of collating a plurality of types of paper classified based on at least one parameter, and a printing apparatus that processes a print job to perform printing, the information processing apparatus comprising: a print job generation unit configured to generate the print job; an acquisition unit configured to acquire information regarding paper feed stages of the printing apparatus; a designation unit configured to, when a determination has been made that there are more types of paper to be used in printing of the print job than the number of paper feed stages of the printing apparatus, based on a condition predetermined such that values of the parameter are considered to be the same in a certain range, designate papers having parameter values considered to be the same among the plurality of types of paper as one set; a collation job generation unit configured to generate a collation job for discharging to one discharge stage of the collation apparatus the one set designated by the designation unit from the plurality of types of paper that have been placed in the respective paper feed stages of the collation apparatus; and a first control unit configured to send the collation job generated by the collation job generation unit to the collation apparatus.

The present invention in its second aspect provides a method for controlling an information processing apparatus capable of connection to a collation apparatus capable of collating a plurality of types of paper classified based on at least one parameter, and a printing apparatus that processes a print job to perform printing, the control method comprising the steps of: generating the print job; acquiring information regarding paper feed stages of the printing apparatus; when a determination has been made that there are more types of paper to be used in printing of the print job than the number of paper feed stages of the printing apparatus, based on a condition predetermined such that values of the parameter are considered to be the same in a certain range, designating papers having parameter values considered to be the same among the plurality of types of paper as one set; generating a collation job for discharging to one discharge stage of the collation apparatus the one set designated from the plurality of types of paper that have been placed in the respective paper feed stages of the collation apparatus; and sending the generated collation job to the collation apparatus.

The present invention in its third aspect provides a computer-readable storage medium that stores a program for causing a computer, the computer being capable of connection to a collation apparatus capable of collating a plurality of types of paper classified based on at least one parameter and a printing apparatus that processes a print job to perform printing, to function so as to: generate the print job; acquire information regarding paper feed stages of the printing apparatus; when a determination has been made that there are more types of paper to be used in printing of the print job than the number of paper feed stages of the printing apparatus, based on a condition predetermined such that values of the parameter are considered to be the same in a certain range, designate papers having parameter values considered to be the same among the plurality of types of paper as one set; generate a collation job for discharging to one discharge stage of the collation apparatus the one set designated from the plurality of types of paper that have been placed in the respective paper feed stages of the collation apparatus; and send the generated collation job to the collation apparatus.

According to the present invention, it is possible to reduce a burden on a user when processing a print job that uses paper of more types than there are paper feed stages.

Further features of the present invention will become apparent from the following description of exemplary embodiments with reference to the attached drawings.

### BRIEF DESCRIPTION OF THE DRAWINGS

FIGS. 1A and 1B show the configuration of a printing system.

FIG. 2 is a drawing for describing a print job.

FIG. 3 shows paper information that is registered in a paper database.

FIG. 4 shows an example of parameters for performing image forming control.

FIG. 5 shows an example of paper sets.

FIG. 6 shows an example of information regarding paper feed stages of a printer.

FIG. 7 shows an example of paper information based on paper sets and paper feed stage information.

FIGS. 8A and 8B are flowcharts that show a sequence of processing of a print job in a first embodiment.

FIG. 9 shows an example of a print job ticket sent to a printing apparatus.

FIG. 10 shows an example of a print job ticket that has been updated.

FIG. 11 shows an example of a print job ticket sent to a collation apparatus.

FIG. 12 shows an example of a screen that instructs placement of paper in the collation apparatus.

FIG. 13 shows an example of a screen that instructs movement of paper from the collation apparatus to the printing apparatus.

FIG. 14 shows an example of a screen that instructs movement of paper from the collation apparatus to the printing apparatus in a second embodiment.

FIG. 15 is a flowchart that shows a sequence of processing of a print job in this embodiment.

FIG. 16 shows an example of paper information in this embodiment.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. The same reference numerals are assigned to the same constituent elements, and a repeated description thereof is omitted.

### Embodiment 1

### Overall Configuration of Printing System

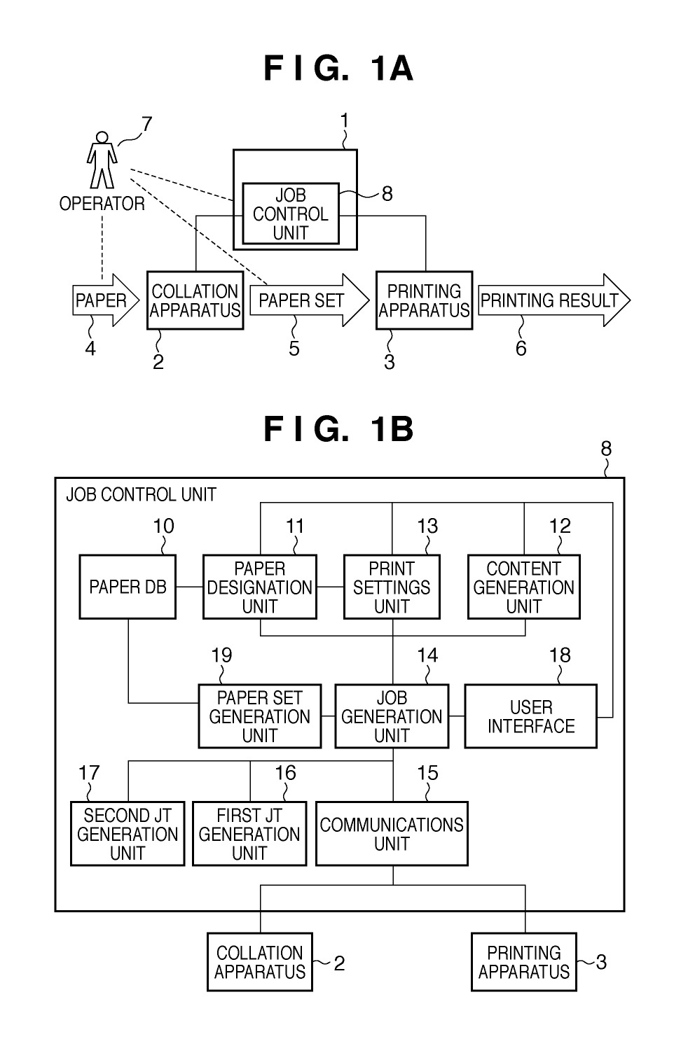

FIGS. 1A and 1B show an example of the configuration of a printing system in an embodiment according to the present invention. As shown in FIG. 1A, the printing system includes an information processing apparatus 1 including a job control unit 8, a collation apparatus 2, and a printing apparatus 3. The information processing apparatus 1 is, for example, a general-purpose PC that includes a CPU, a ROM, a RAM, an input unit such as a keyboard, a display unit such as a display, and so forth. Here, the collation apparatus 2 is connectable online with the information processing apparatus 1, and is separated from the printing apparatus 3. That is, an operator or the like transports paper that has been collated by the collation apparatus 2 to the printing apparatus 3. Then, the printing apparatus 3 performs printing using the paper that has been transported. The collation apparatus 2 sorts paper 4 in a predetermined order according to an instruction of the job control unit 8 of the information processing apparatus 1, and designates and outputs a paper set 5 that is a set of the paper that has been sorted. The printing apparatus 3, according to an instruction of the job control unit 8 of the information processing apparatus 1, processes the print job, feeds the paper set 5 and outputs a printing result 6. An operator 7, according to an instruction displayed by the job control unit 8 of the information processing apparatus 1, places the paper 4 in the collation apparatus 2, and transports the paper set 5 to the printing apparatus 3 and places the paper set 5 in the printing apparatus 3.

The printing apparatus 3 processes a print job including a job ticket in which print settings information has been described and content data. The printing apparatus 3 receives the print job from the information processing apparatus 1 and processes the print job. The printing apparatus 3, according to the job ticket of the print job, feeds paper from a designated paper feed stage and performs printing. In the printing apparatus 3, paper information that has been associated with the paper feed stage in advance is registered. The printing apparatus 3, when performing printing, according to that registered paper information, performs image forming control of the paper in the printing. Registration of the paper information can be performed with an operation panel installed in the main body of the printing apparatus 3, and can also be performed with an instruction from the job control unit 8 of the information processing apparatus 1 that has been connected. Also, when a paper type has been designated in the job ticket of the print job, the printing apparatus 3, according to the paper information that has been associated with the paper feed stage and registered, feeds paper of that type from the appropriate paper feed stage. If an appropriate paper has not been registered for any paper feed stage, the operator 7 exchanges paper according to guidance by the operation panel of the printing apparatus 3. Ordinarily, when processing a print job for which it is necessary to use paper of more types than the number of paper feed stages, such an exchange operation is performed. The collation apparatus 2 receives a job ticket of a collation job, performs sorting of paper according to the order that has been designated in the job ticket, and generates a paper set that is a set of the sorted paper.

FIG. 1B is a block diagram that shows the configuration within the job control unit 8 of the information processing apparatus 1. The job control unit 8 generates a print job with a job generation unit 14 and sends the print job to the printing apparatus 3. Also, the job control unit 8 performs control such that the collation apparatus 2 performs collation processing if necessary. A content generation unit 12 generates content data to be printed such as image data, PDL data, and VDP data, and outputs the generated data to the job generation unit 14. At this time, there are also cases where file selection or the like by a user is performed via a user interface 18. A print settings unit 13 sends to the job generation unit 14 print settings that have been received via the user interface 18 and are to be set for a print job. A paper designation unit 11 receives a paper selection by the user via the user interface 18, and in cooperation with the print settings unit 13, from among paper types that have been registered in a paper database 10, designates the paper to be used in the print processing in sheet units. Also, the paper designation unit 11 newly registers a new paper that has been received via the user interface 18 in the paper database 10.

The job generation unit 14 generates a print job according to the information from the content generation unit 12, the print settings unit 13, and the paper designation unit 11. The job generation unit 14 acquires the information regarding paper feed stages provided in the printing apparatus 3, from the printing apparatus 3 via a communications unit 15. The job generation unit 14 determines from that paper feed stage information whether or not it is necessary to generate a paper set with the collation apparatus 2. Here, when determined that generation of a paper set is necessary, a paper set generation unit 19 generates a paper set using the paper that is registered in the paper database 10. The job generation unit 14 registers the paper information (the paper set that has been associated with the paper feed stage) used in the print job in the printing apparatus 3 via the communications unit 15, according to the print job and the paper set information. A first job ticket generation unit 16 generates a print job ticket for the printing apparatus 3 based on the print job and the paper set information. A second job ticket generation unit 17 generates a job ticket for the collation apparatus 2 based on the paper set information. The job generation unit 14 sends the respective job tickets to the collation apparatus 2 and the printing apparatus 3 via the communications unit 15. Also, the job generation unit 14, when a job ticket has been sent, displays an operation instruction to the operator of the collation apparatus 2 and the printing apparatus 3 in the user interface 18.

Example Print Job

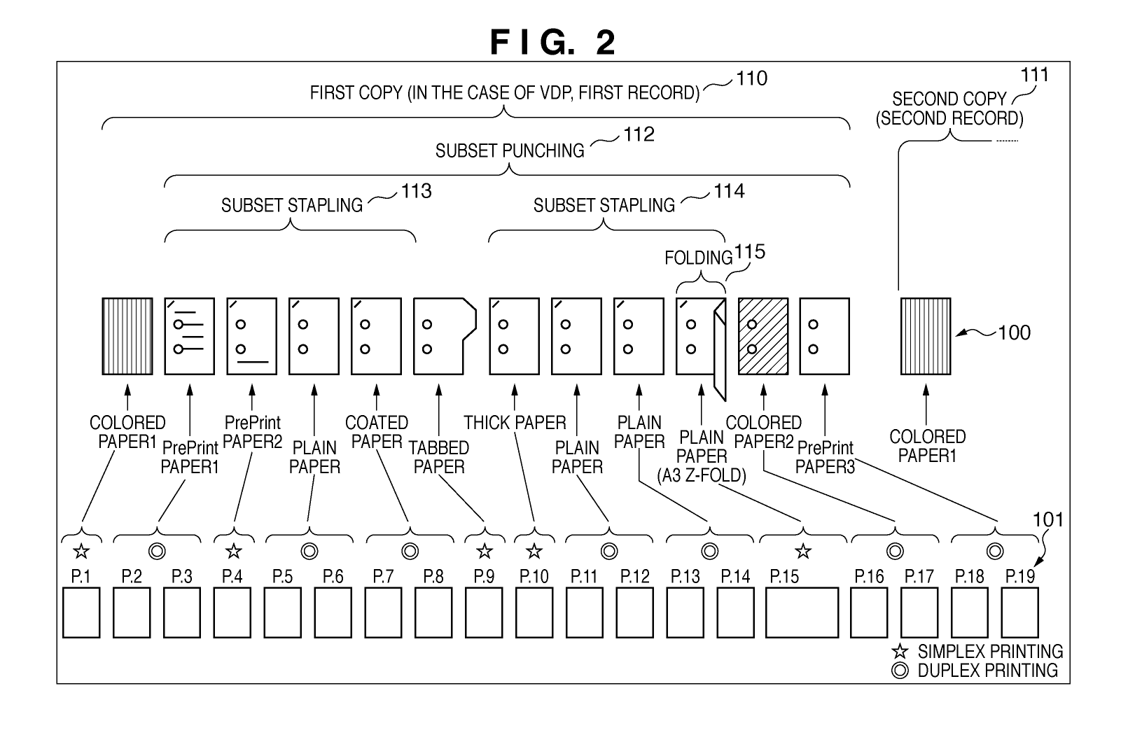

FIG. 2 shows output of a print job in the present embodiment. In the present embodiment, by way of example, a VDP print job is described in which print content differs between copies. With one print job, printing of a plurality of records (a plurality of copies) is performed. Here, in each record, the print content of that record differs, but the paper used, and post-processing such as stapling and hole-punching, are the same for all records. An output 100 indicates the state of paper that has been output, from left to right. Also, pages 101 show pages that correspond to the output 101. That is, the content data of the respective pages of the pages 101 is printed to a face of respective sheets of paper. In FIG. 2, the print content is omitted, but printing is performed according to the above-described content data. An output 110 indicates output of a first record (first copy). An output 111 indicates part of a second record (second copy), and output from the second record onward is repeated in the same form as the first record. In the present embodiment, as shown in FIG. 2, 12 sheets of paper are used for one record. An output 112 indicates that punch processing is performed from the second sheet to the twelfth sheet for the print output of one record. Further, an output 113 indicates that staple processing is performed at the upper left corner of the second sheet to the fifth sheet. Also, an output 114 indicates that staple processing is performed at the upper left corner of the seventh sheet to the tenth sheet. Also, an output 115 indicates that Z-fold processing of the tenth sheet is performed. As indicated in the pages 101, in the present embodiment, 19 pages of content data correspond to one record. Also, the designated page size partially differs from the size of other pages, with the output 115 designated as A3 Z-fold. For example, the fifteenth page is designated as A3 landscape size, and other pages are designated as A4 portrait size. The sizes of the paper to be fed are respectively adapted to the designated page sizes. Output of differing print content is repeated from the second record onward in the same form as the first record.

Paper Information

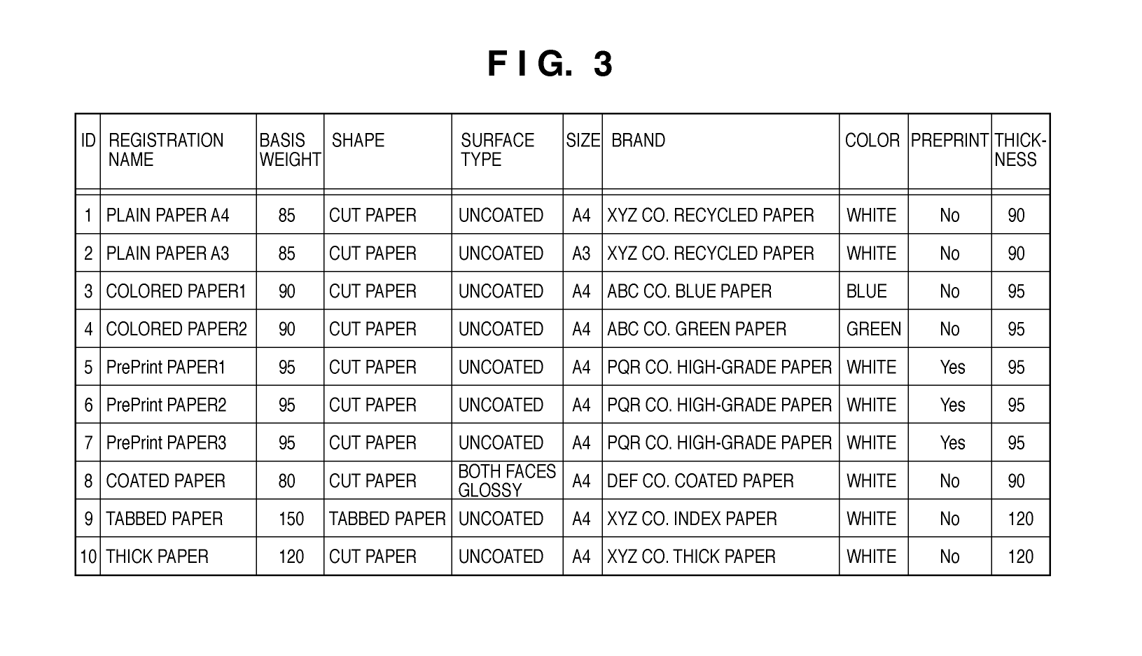

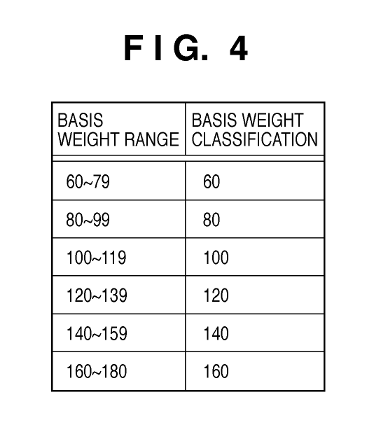

FIG. 3 shows an example of the paper information registered in the paper database 10. In FIG. 3, the first column shows an identifier that identifies the type of paper. The second column shows a registration name that was input by a user via the user interface 18 in order to identify the type of paper. The third column shows a basis weight (g/m²) of the paper. The fourth column shows the shape of the paper. In the present embodiment, the shape of the paper includes types such as “cut paper” that is an ordinary rectangular shape, “with tab” that is a tabbed shape, and “punched paper” in which holes have been formed in advance. The fifth column shows the state of the paper surface. In the present embodiment, for example, the state of the paper surface includes types such as “uncoated” in which the surface is not coated, and “front face glossy”, “back face glossy”, and “both faces glossy” in which a gloss coating has been applied on the paper surface. The sixth column shows the size of paper. The seventh column shows a brand name of paper. For example, this is a name for identifying the type of paper when paper was purchased by a user. The eighth column shows the color of paper. The ninth column shows a classification of whether or not the paper is preprint paper. The tenth column shows the thickness (μm) of paper. The 12 sheets of paper used for printing the first record shown in FIG. 2 can be represented using the IDs shown in FIG. 3 as “3, 5, 6, 1, 8, 9, 10, 1, 1, 2, 4, 7”. The printing apparatus 3, switches image forming control in print processing based on the four parameters of basis weight, shape, surface type, and paper size. That is, the paper used for printing in the printing apparatus is classified based on the values of those parameters. Also, regarding the basis weight, the same image forming control is performed if the basis weight is within a predetermined fixed range, as in the table shown in FIG. 4 (an example of a first table). The first table is a condition for classifying paper in a set. For example, as shown in FIG. 4, paper having a basis weight of 80 to 99 g/m² is handled as paper having a basis weight of 80 g/m². Accordingly, the printing apparatus 3 can execute image forming control by the same process even though the basis weight is different, if the parameters of the shape, the surface type, and the paper size are the same. The paper set generation unit 19 generates a paper set from a list of the papers that have been registered in the paper database 10 according to the above parameters.

Paper Set Information

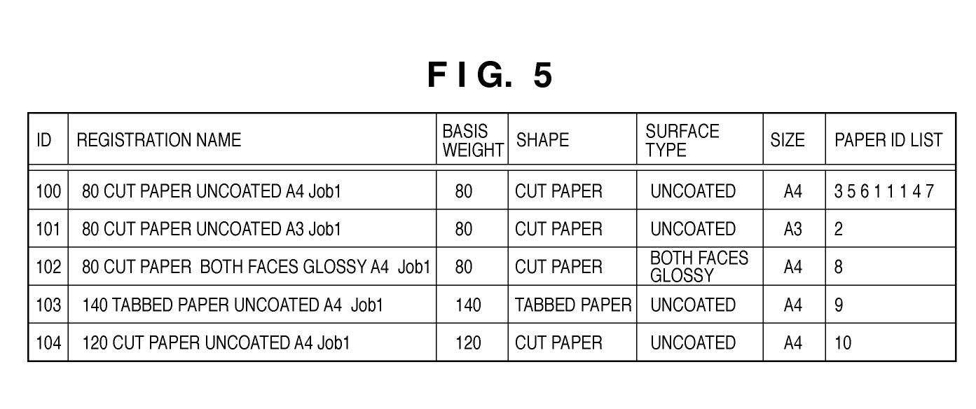

FIG. 5 shows an example of a paper set that has been generated by the paper set generation unit 19 based on the paper information shown in FIG. 3 and the print job shown in FIG. 2. The first column shows an identifier that identifies the paper set. The second column shows a registration name for identifying the paper set when the paper set is registered by a user. In the present embodiment, for example, names are automatically created linked with the values of the parameters of the paper set. The third column shows a basis weight (g/m²) of the paper. This value is the value of the basis weight classification shown in FIG. 4, and therefore the actual basis weight may differ. The fourth column shows the shape of the paper. The fifth column shows the state of the paper surface. The sixth column shows the size of paper. The seventh column shows the ID of the paper to be used for printing of the print job. In the seventh column, the IDs of the paper that has been registered in the paper database 10 shown in FIG. 3 are entered in an order that has been designated by the print job shown in FIG. 2. The job generation unit 14 registers the paper set shown in FIG. 5 in the printing apparatus 3 so as to correspond with the paper feed stages of the printing apparatus 3. In order to perform that registration, the job generation unit 14 acquires information of the paper feed stages provided in the printing apparatus 3 from the printing apparatus 3. The printing apparatus 3, in response to a request from the information processing apparatus 1, sends a reply with information of the paper feed stages provided in the printing apparatus 3.

Paper Feed Stage Information

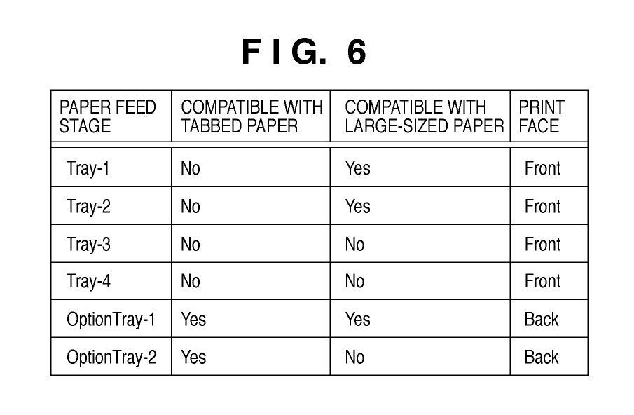

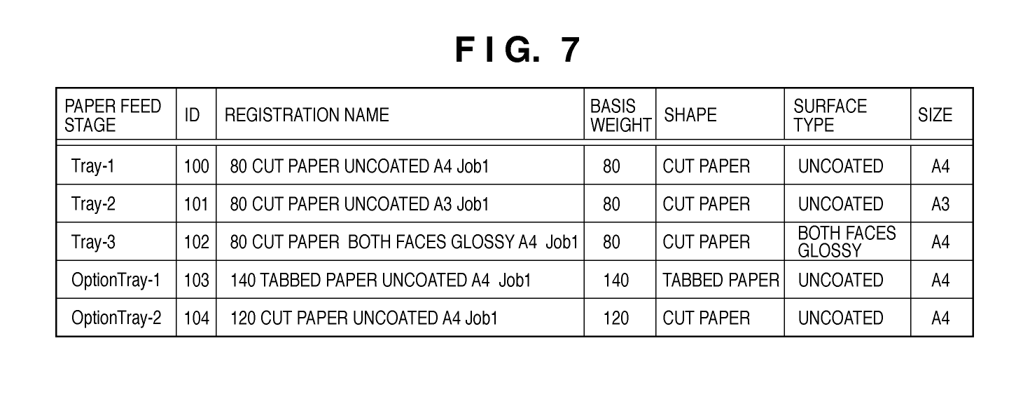

FIG. 6 shows an example of the paper feed stage information of the printing apparatus 3 sent by the printing apparatus 3 as a reply in response to the request from the information processing apparatus 1. As shown in FIG. 6, the printing apparatus 3 is provided with six paper feed stages. The information processing apparatus 1, from the information shown in FIG. 6, can be aware of information regarding paper restrictions or the like for each paper feed stage of the printing apparatus 3. The first column shows the name of the paper feed stage. By designating a paper feed stage name in the job ticket of the print job, it is possible for the job control unit 8 of the information processing apparatus 1 to select a predetermined paper feed stage provided in the printing apparatus 3, and thus cause paper to be fed from that paper feed stage. The second column shows whether or not that paper feed stage is compatible with tabbed paper. Here, tabbed paper can be placed in and fed by a paper feed stage for which “Yes” is designated. Tabbed paper cannot be placed in and fed from a paper feed stage for which “No” is designated. The third column shows the corresponding paper size. In the present embodiment, with predetermined sizes serving as a boundary, a distinction is made between a small size such as A4 or letter size, and a large size such as A3 or ledger size. Here, paper of an arbitrary size including also a large size can be fed by a paper feed stage for which “Yes” is designated. Only paper of a small size can be fed by a paper feed stage for which “No” is designated. The fourth column shows whether the first face to be printed of the paper that has been fed from the corresponding paper feed stage is the front face or the back face. This is information for performing control such that printing is performed to a predetermined face in the case of preprint paper, for example. The job generation unit 14, from the paper set information shown in FIG. 5 and the paper feed stage information of the printing apparatus 3 shown in FIG. 6, generates paper set registration information corresponding to each paper feed stage of the printing apparatus 3, shown in FIG. 7.

Paper Set Registration Information

FIG. 7 shows an example of the paper set registration information registered in the printing apparatus 3. Based on the table (an example of a second table) shown in FIG. 7, the respective paper feed stages of the printing apparatus 3 are associated with the respective paper sets. The first column shows the name of each paper feed stage. The second column shows an identifier of the paper set registered in association with a paper feed stage. The third column shows the name of the registered paper set. The fourth column shows the basis weight of the registered paper set. The fifth column shows the shape of the registered paper set. The sixth column shows the surface type of the registered paper set. The seventh column shows the size of the registered paper set. That is, the second to seventh columns in FIG. 7 are the same as the first to sixth columns shown in FIG. 5. By registering information as shown in FIG. 7 in the printing apparatus 3, the printing apparatus 3 can perform paper transport and appropriate image forming control according to the set of paper fed from the predetermined paper feed stage.

Print Job Processing

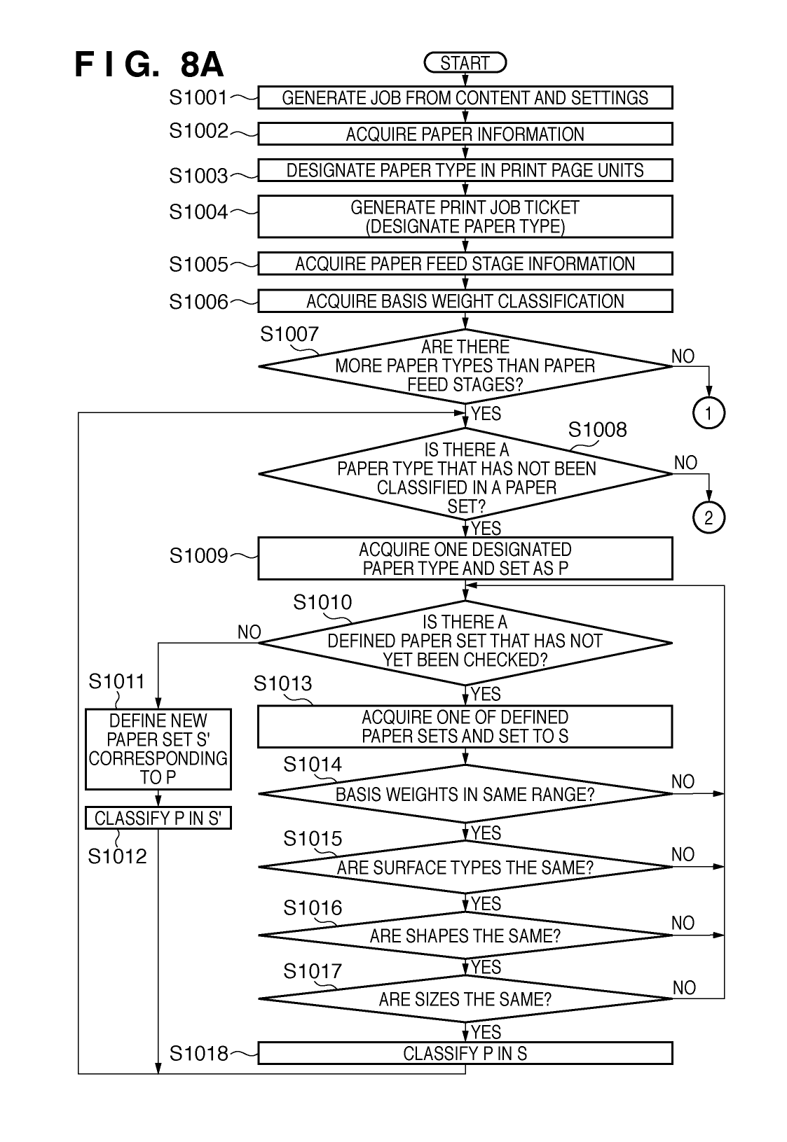

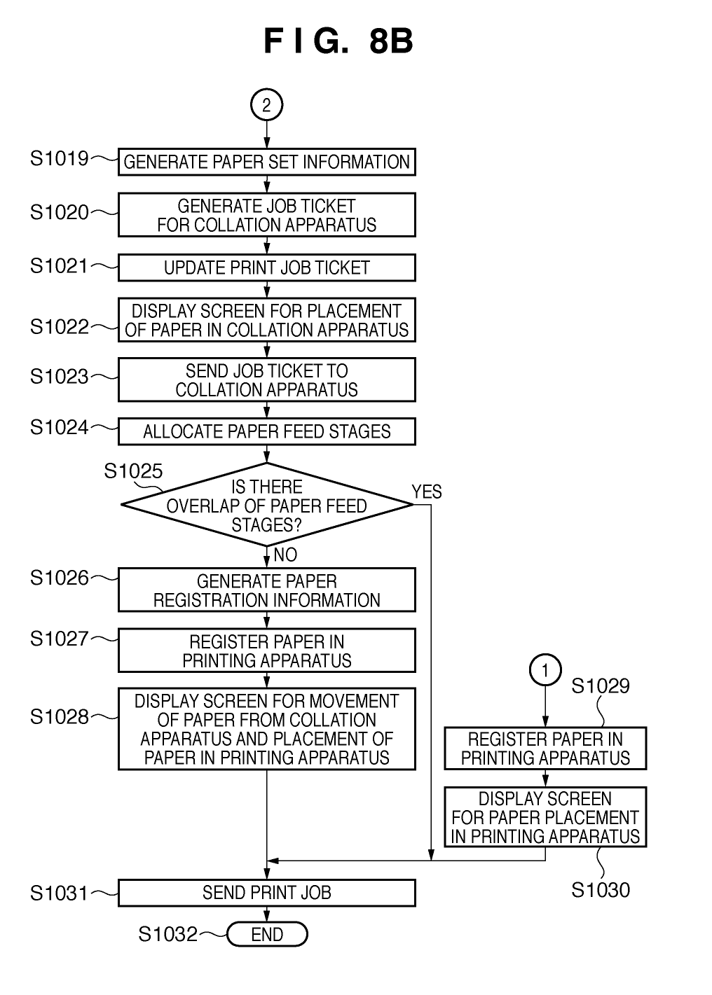

FIGS. 8A and 8B are flowcharts that show a sequence of processing of a print job in the job control unit 8 of the information processing apparatus 1. The processing shown in FIGS. 8A and 8B, for example, is executed by a CPU installed in the information processing apparatus 1. The job generation unit 14 generates a print job based on the content data that has been output from the content generation unit 12 and the print settings that have been output from the print settings unit 13 (S1001). The paper designation unit 11 acquires paper information as shown in FIG. 3 from the paper database 10 (S1002). The paper designation unit 11 designates a paper type for each page of the generated print job based on the acquired paper information (S1003). The first job ticket generation unit 16 generates a print job ticket for sending to the printing apparatus 3 according to the paper type designated for each page (S1004, an example of print job generation).

Next, the job generation unit 14 acquires information of the paper feed stages provided in the printing apparatus 3 from the printing apparatus 3, via the communications unit 15 (S1005). This information of the paper feed stages is information as shown in FIG. 6. Also, the job generation unit 14 acquires information of the basis weight classification as shown in FIG. 4 (S1006).

Next, the job generation unit 14 determines whether or not the collation apparatus 2 is used in the processing of the generated print job (S1007). In the present embodiment, the job generation unit 14 determines that the collation apparatus 2 is used when there are more paper types used in printing by the generated print job than there are paper feed stages of the printing apparatus 3, and then processing advances to S1008. On the other hand, when there are not more paper types used in printing by the generated print job than there are paper feed stages of the printing apparatus 3, processing advances to S1029.

Next, the paper set generation unit 19 determines whether or not, among the paper types that are designated in the print job, there is a paper type that has not been classified in a paper set (S1008). Here, when determined that there is a paper type that has not been classified in a paper set, processing advances to S1019. On the other hand, when determined that there is not a paper type that has not been classified in a paper set, processing advances to S1009. Next, one paper type among the paper types that have not been classified in a paper set is made the target of processing. Here, the paper type made the target of processing is set as a paper type P (S1009). In S1010, a determination is made of whether or not there is a paper set that has not yet been compared to the paper type P. Here, when determined that there is a paper set that has not yet been compared to the paper type P, processing advances to S1013, and on the other hand, when determined that there is not a paper set that has not yet been compared to the paper type P, processing advance to S1011. In S1010, also in a case where there is not a target paper set to be compared to the paper type P, that is, also in a case where information as shown in FIG. 5 has not been generated by the paper set generation unit 19, processing advances to S1011.

In S1013, the paper set generation unit 19 acquires one paper set that has not yet been compared to the paper type P from the paper sets shown in FIG. 5. Here, the acquired paper set is set to a paper set S. In S1014, the paper set generation unit 19 determines whether or not the basis weight of the paper type P is the same as the basis weight of the paper set S. When making this determination, with reference to the table shown in FIG. 4, if the ranges of those basis weights are the same, the basis weights are determined to be the same. When the basis weights are determined to be the same, processing advances to S1015. On the other hand, when the basis weights are determined to be different, processing returns to S1010, and another paper set is compared to the paper type P.

In S1015, the paper set generation unit 19 determines whether or not the surface type of the paper type P is the same as the surface type of the paper set S. Here, when determined that the surface types are the same, processing advances to S1016. On the other hand, when determined that the surface types are different, processing returns to S1010, and another paper set is compared to the paper type P.

In S1016, the paper set generation unit 19 determines whether or not the shape of the paper type P is the same as the shape of the paper set S. Here, when determined that the shapes are the same, processing advances to S1017. On the other hand, when determined that the shapes are different, processing returns to S1010, and another paper set is compared to the paper type P.

In S1017, the paper set generation unit 19 determines whether or not the size of the paper type P is the same as the size of the paper set S. Here, when determined that the sizes are the same, processing advances to S1018. On the other hand, when determined that the sizes are different, processing returns to S1010, and another paper set is compared to the paper type P.

In S1018, the paper type P is classified in the paper set S. That is, for each paper type included in the new paper set S that includes the paper type P, in the printing apparatus 3, image forming control by the same process can be performed. After the processing of S1018, processing returns to S1008, and another paper type is set as the processing target.

The following description refers again to S1010. In S1010, when determined that there is not a paper set that has not been compared to the paper type P, in S1011, the paper set generation unit 19 defines a new paper set. Here, the new paper set that has been defined is set to a paper set S′. In S1012, the paper type P is classified in the paper set S′, and then processing returns to S1008.

As described above, when determined that all of the paper types that have been designated in the generated print job have been classified in a paper set, processing advances to S1019, and the paper set generation unit 19 generates paper set information as shown in FIG. 5.

In S1020, the second job ticket generation unit 17 generates a job ticket for sending to the collation apparatus 2 from the generated paper set information (an example of collation job generation). In S1021, the first job ticket generation unit 16 updates the print job ticket for sending to the printing apparatus 3 according to the generated paper set information. Updating of the print job ticket will be described later, but designation according to the paper type is replaced by designation according to the paper set.

In S1022, the job generation unit 14 displays a screen showing a sequence for placing paper in the collation apparatus 2. When the operator 7 places paper in the collation apparatus 2 according to the paper placement sequence, the job generation unit 14, in S1023, sends the job ticket that was generated in S1020 to the collation apparatus 2. In the collation apparatus 2, when processing is performed according to that job ticket, the paper from each paper feed stage of the collation apparatus 2 is collated, and the paper set is discharged from respective discharge stages (an example of a first control).

In S1024, the job generation unit 14 allocates respective paper sets that satisfy conditions to the respective paper feed stages indicated in the paper feed stage information of the printing apparatus 3 that was acquired in S1005. For example, a paper feed stage “Tray-1” of the printing apparatus 3 shown in FIG. 6 is not compatible with tabbed paper, and is compatible with large-sized paper. Accordingly, a paper set of A3 size plain paper is allocated to that paper feed stage so as to satisfy those compatibility conditions. A paper feed stage “OptionTray-2” of the printing apparatus 3 is compatible with tabbed paper. Accordingly, a paper set having tabbed paper is allocated to that paper feed stage. A paper feed stage “OptionTray-1” of the printing apparatus 3 is compatible with both tabbed paper and large-sized paper. Accordingly, both tabbed paper and A3-sized paper can be allocated. When the number of paper feed stages that satisfy the conditions is less than the number of corresponding paper sets, a plurality of paper sets may be allocated to a single paper feed stage. Also, when allocating the respective paper sets to the respective paper feed stages, with reference to the information regarding print faces shown in FIG. 6, the direction in which the paper set is placed (front-facing or back-facing) is set for each paper feed stage.

Next, in S1025, a determination is made of whether or not as a result of performing allocation of paper feed stages, overlap has occurred. Here, overlap refers to a case where one paper set has been allocated to two paper feed stages of the printing apparatus 3. When determined that overlap has occurred, processing advances to S1031 without registering paper in the printing apparatus 3, described later. In this case, the operator 7 performs paper registration in the printing apparatus 3 by a panel operation of the printing apparatus 3. On the other hand, a determination that overlap did not occur means that all of the paper sets that have been designated in the updated print job were uniquely allocated to respective paper feed stages of the printing apparatus 3. In this case, processing advances to S1026.

In S1026, the job generation unit 14 generates paper set registration information to be registered in the printing apparatus 3 as shown in FIG. 7 (an example of table generation). In S1027, the job generation unit 14 sends the generated paper set registration information to the printing apparatus 3, and registers that information therein.

Next, in S1028, the job generation unit 14 displays a screen that instructs that the paper sets that have been collated be moved from the collation apparatus 2 to the respective paper feed stages of the printing apparatus 3 and placed there.

When determined in S1007 to not use the collation apparatus 2, that is, when determined that the number of paper types to be used in the print processing is no more than the number of paper feed stages of the printing apparatus 3, in S1029, the paper types that have been designated in the print job are sent to and registered in the printing apparatus 3. In this case, paper sets are not allocated to the respective paper feed stages of the printing apparatus 3 as described above, but rather, paper information is allocated to the respective paper feed stages of the printing apparatus 3 using the paper information as shown in FIG. 3 and the paper feed stage information as shown in FIG. 6. In S1030, the job generation unit 14 displays a screen showing only the sequence of paper placement in the printing apparatus 3.

When placement by the operator 7 in S1028 and S1030 is completed, the job generation unit 14, in S1031, sends the print job ticket to the printing apparatus 3, causes the printing apparatus 3 to execute printing (an example of a second control), and then ends this processing.

Print Job and Print Job Ticket

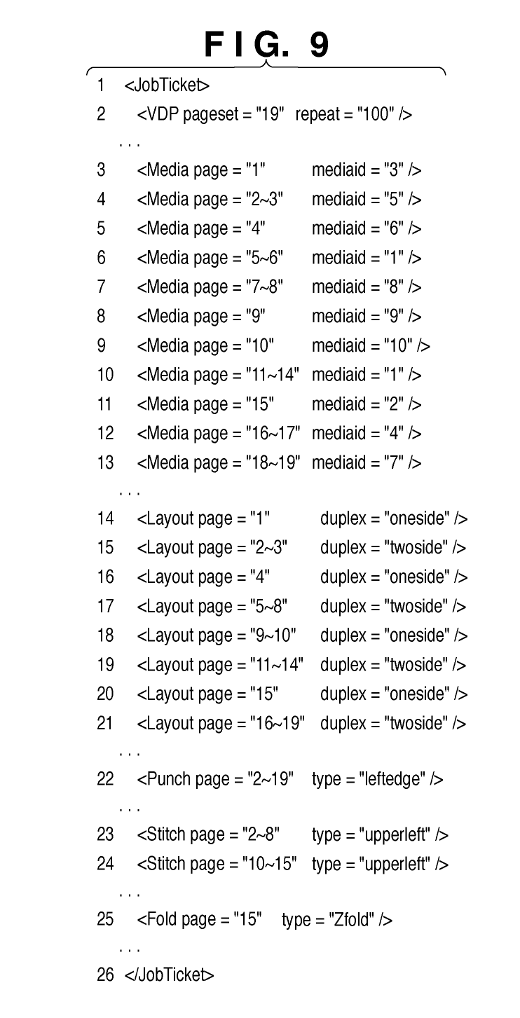

Next is a description of a print job ticket generated by the first job ticket generation unit 16 in the present embodiment. FIG. 9 shows an example of the print job ticket generated in S1004 in FIG. 8A. The print job ticket is a text document using a markup language defined with XML. However, for the sake of description, simple expressions are used in FIG. 9, so these expressions do not strictly comply with XML specifications.

The 2nd line shown in FIG. 9 indicates that VDP content is set as the content designated by this print job ticket, and output of 100 records will be repeated in 19-page units. The description from the 3rd line onward also is made regarding that 19-page unit.

From the 3rd line to the 13th line, designation of output paper types corresponding to print pages is described. For example, the 3rd line designates that the ID is “3” for the paper type to be used for the 1st page of printing. The ID of “3” indicates “colored paper 1” as shown in FIG. 3. Also, the 4th line designates that the ID is “5” for the paper type to be used for the 2nd to 3rd pages of printing. The ID of “5” indicates “preprint paper 1” as shown in FIG. 3. Likewise, in the 4th to 13th lines below, paper types corresponding to a single page or a range of a plurality of pages are designated.

In the 14th to 21st lines, designation of print layouts is described. For example, in the 14th line, simplex printing of the first page is designated. In the 15th line, duplex printing is designated for the second to third pages. Likewise, in the 16th to 21st lines below, a print layout is designated for each page so as to result in print settings as shown in FIG. 2.

In the 22nd line, designation of punching is described. This description corresponds to the output 112 shown in FIG. 2. An instruction to perform punching at the left edge in a range from the 2nd page to the 19th page is described.

The descriptions in the 23rd and 24th lines respectively correspond to the outputs 113 and 114 shown in FIG. 2. The 23rd line describes an instruction to perform stapling in the upper left corner in a range from the 2nd page to the 8th page. The 24th line likewise describes an instruction to perform stapling in the upper left corner in a range from the 10th page to the 15th page. The description in the 25th line corresponds to the output 115 shown in FIG. 2. This describes an instruction to perform Z-folding of the 15th page.

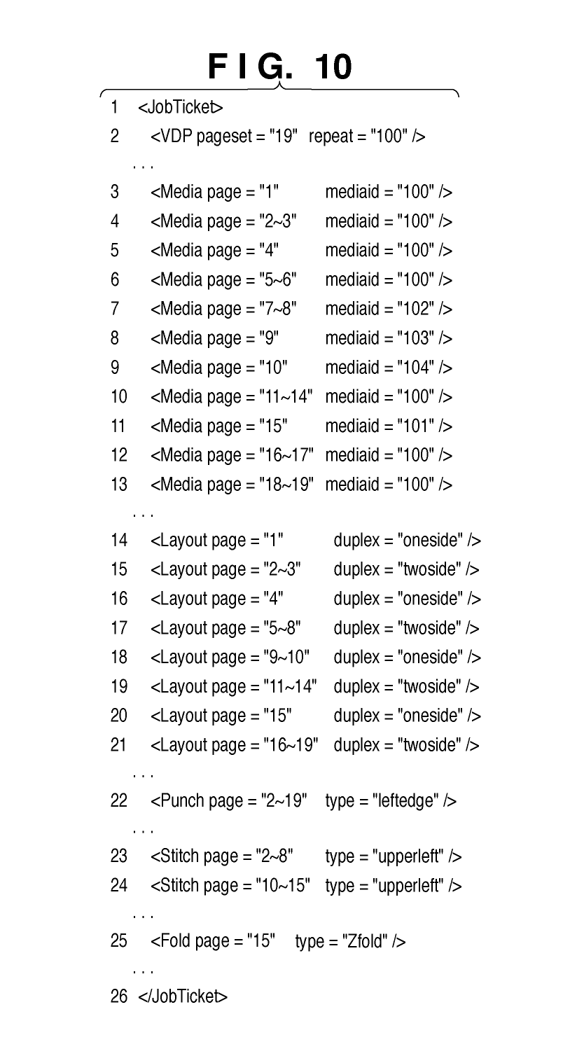

FIG. 10 shows an example of a print job ticket that has been updated by the processing of S1021 in FIG. 8B. Following is a description of differences between FIGS. 9 and 10.

The designation of paper types in the 3rd to 13th lines is replaced by designation of paper sets. For example, for the paper ID designated in the 3rd line, “3” is replaced by “100”. Likewise, paper IDs are replaced by paper set IDs according to the paper set information shown in FIG. 5. In FIG. 10, in order to simply show the manner of replacement, a print job ticket is shown in which the paper IDs have merely been replaced by paper set IDs. However, when there are continuous designations of the same paper set ID, those may be collectively described in a single designation. For example, the designations in the 3rd to 6th lines in FIG. 10 may collectively be described as “<Media page=”1˜6″ mediaid=“100”/>”. The other descriptions in FIG. 10 are the same as described above with reference to FIG. 9.

Next is a description of a job ticket generated by the second job ticket generation unit 17 in the present embodiment.

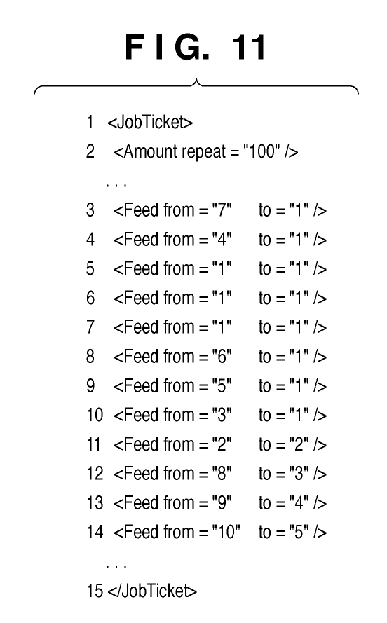

FIG. 11 shows an example of the job ticket generated in S1020 in FIG. 8B. The 2nd line shown in FIG. 11 indicates that the collation processing designated in the 3rd to 14th lines of the present job ticket will be repeated 100 times.

In the descriptions given in order beginning from the 3rd line, paper feed stages and discharge stages of the collation apparatus 2 are designated, and there is an instruction to transport paper to generate a predetermined paper set. For example, in the 3rd line, an instruction is given to feed paper from a 7th paper feed tray, and discharge that paper to a 1st discharge tray. In the 4th line, an instruction is given to feed paper from a 4th paper feed tray, and discharge that paper to the 1st discharge tray. Paper feed and discharge is performed without reversing the paper, so that paper is stacked in order from bottom to top.

Paper having the ID “1” shown in FIG. 3 is placed in the 1st paper feed stage of the collation apparatus 2. Paper having the ID “2” shown in FIG. 3 is placed in the 2nd paper feed stage. Below, paper having an ID of “n” is sequentially placed in the nth paper feed stage. As a result, by the collation apparatus 2 performing processing according to the description in the 3rd to 14th lines in FIG. 11, the paper set having the ID “100” shown in FIG. 5 is discharged to the 1st paper discharge stage. Below, likewise, paper sets having the IDs “101” to “104” are discharged in order to the 2nd to 5th paper discharge stages.

Because the paper is stacked from bottom to top without being reversed, the order of the paper feed stages described in the 3rd to 10th lines is opposite to the description in the paper ID list for the paper set having the ID “100” in FIG. 5.

User Interface Screen

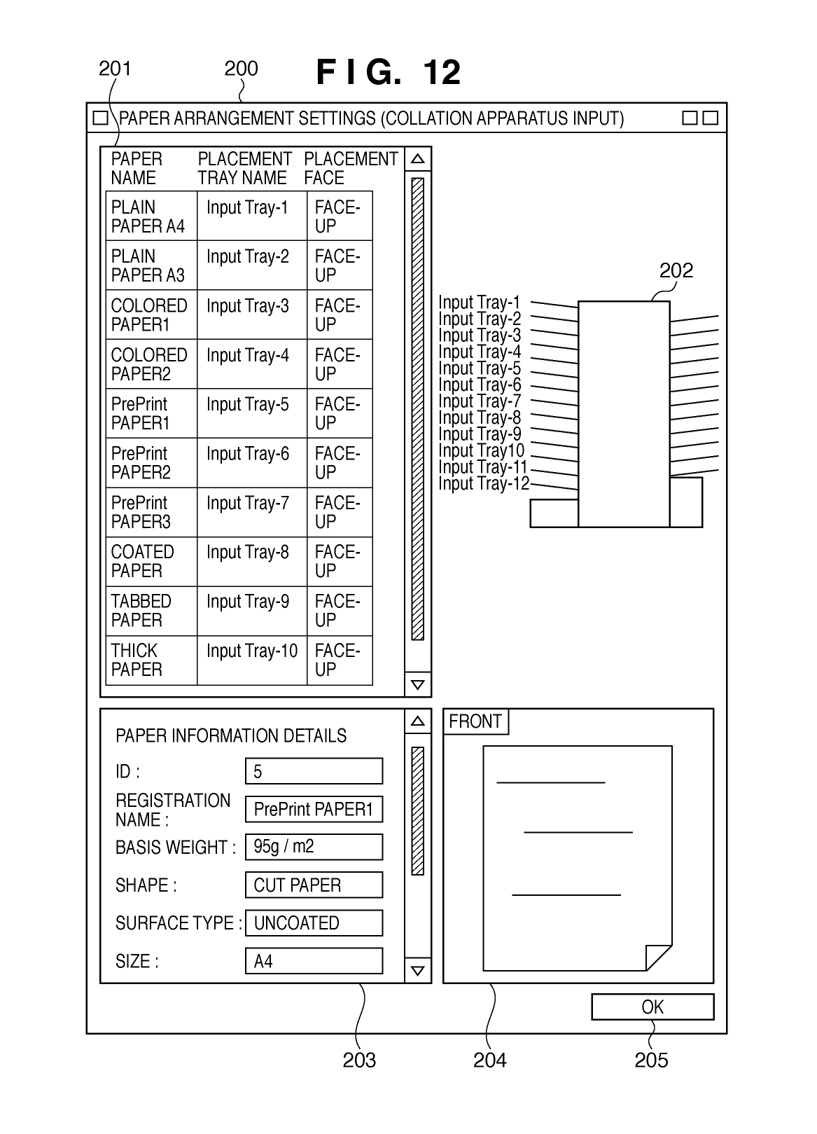

Next is a description of a user interface screen displayed in a screen of the information processing apparatus 1. FIG. 12 shows an example of the screen displayed in S1022 of FIG. 8B that instructs placement of paper in the collation apparatus 2 (an example of a first display). In FIG. 12, a display 200 is divided into four display areas. A display 201 displays the paper to be placed in the respective paper feed stages of the collation apparatus 2, and the direction of that paper. In the leftmost first column, the name of the paper to be placed is displayed. For example, the registration name shown in FIG. 3 is displayed as this name. In the second column, the name of the tray where that paper is to be placed is displayed. The third column displays whether when placing the paper, the paper is to be placed with the front facing upward or the back facing upward. The user checks the display shown in FIG. 12, and places the respective paper in predetermined paper feed stages in the predetermined direction.

A display 202 is used for checking the paper feed stages of the collation apparatus 2. By checking this display, the user can know the positions in the collation apparatus 2 of the respective paper feed stages shown in the display 201. A display 203 displays details of the respective paper information. By selecting an arbitrary paper from the display 201, the user can check the detailed information of the selected paper in the display 203. In FIG. 12, the detailed information of the preprint paper 1 is displayed. The display 203 performs display based on the respective paper information shown in FIG. 3.

A display 204 shows a preview display of the paper front and back. For example, regarding paper that requires distinguishing between the front and back such as preprint paper, the user can use this screen to check which face is the front. By selecting an arbitrary paper from the display 201, the user can check the preview screen of the selected paper in the display 204. This preview display is displayed based on the paper information that was acquired in S1002 in FIG. 8A. The preview display in the display 204 is performed in coordination with the direction of placement displayed in the display 201.

The user presses an OK button 205 when placement of paper according to the display in the display 200 is completed. When the OK button 205 is pressed, processing advances from S1022 to S1023 in FIG. 8B.

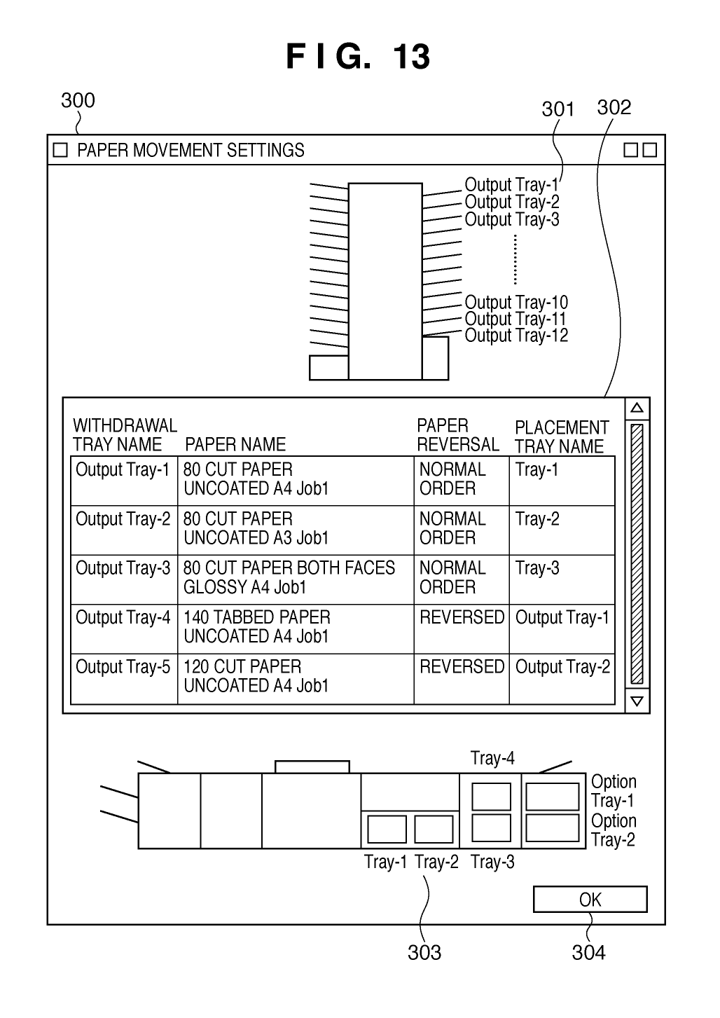

FIG. 13 shows an example of the screen displayed in the display unit of the information processing apparatus in S1028 in FIG. 8B, indicating movement of paper from the collation apparatus 2 to the printing apparatus 3 (an example of a second display). As shown in FIG. 13, the display 300 is divided into three display areas. A display 301 displays the respective discharge stages of the collation apparatus 2. By checking this display, the user can know the positions of the respective discharge stages in the collation apparatus 2. A display 302 displays information for moving paper between the collation apparatus 2 and the printing apparatus 3. In the leftmost first column, the name of the tray from which paper is to be withdrawn from the collation apparatus 2 is displayed. In the second column, the name of the withdrawn paper set is displayed. The third column displays whether or not to reverse the front and back sides when placing the withdrawn paper in the printing apparatus 3. The fourth column displays the name of the paper feed tray of the printing apparatus 3 where the paper is to be placed. As shown in FIG. 13, regarding paper to be placed in an Option Tray-1 and an Option Tray-2, a message is displayed indicating reversal when placing this paper. This is because, as indicated in the paper feed stage information of the printing apparatus 3 in FIG. 6, paper that has been fed from those paper feed stages will be printed starting from the back face. A display 303 is a display for checking the paper feed stages of the printing apparatus 3. By checking this display, the user can know the positions of the respective paper feed stages in the printing apparatus 3.

The user presses an OK button 304 when movement of paper according to the display in the display 300 is completed. When the OK button 304 is pressed, processing advances from S1028 to S1031 in FIG. 8B.

The screen displayed in S1030 in FIG. 8B is the same as the screen shown in FIG. 12. However, when displayed in S1030, the display 202 is a display of the printing apparatus 3 such as the display 303 in FIG. 13. When the user completes paper placement and presses the OK button 205, processing advances from S1030 to S1031.

As described above, in the present embodiment, creation of a paper set in which, among a plurality of paper types of which there are more than the number of paper feed stages of the printing apparatus, paper types having that same image forming control are collected is automatically performed in cooperation with processing to perform a print job. As a result, it is not necessary for the user to change the paper in a paper feed stage of the printing apparatus, so the burden on the user can be reduced. Moreover, by displaying paper placement instructions to the user in screens such as shown in FIGS. 12 and 13, it is possible to reduce mistakes in paper selection and placement direction. Conventionally, in the case of a VDP print job or when attempting to use an inline finisher, the collation apparatus cannot be used after printing output, so the effect of the present embodiment that automation is possible with generation of a collated paper set performed in cooperation with processing of a print job is significant.

### Embodiment 2

In Embodiment 2, only differences from Embodiment 1 will be described. In the present embodiment, collation processing is only performed for paper requiring generation of a paper set. That is, a job ticket for the collation apparatus 2 is generated only when a plurality of paper types are collected as a paper set. Other paper sets are displayed to the user such that the user places paper directly in the printing apparatus 3.

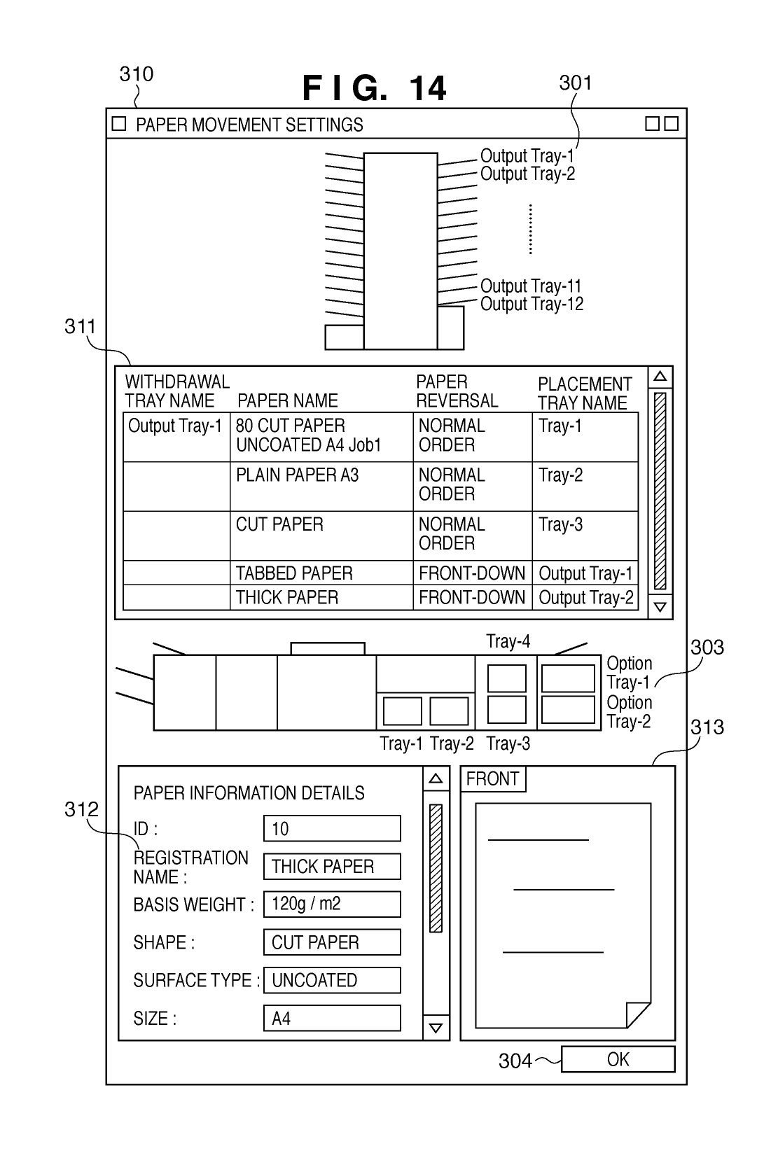

FIG. 14 shows an example of a screen giving a display indicating movement of paper from the collation apparatus 2 to the printing apparatus 3 in the present embodiment. As shown in FIG. 14, a display 310 is divided into five areas. A display 301 is a display for checking the respective discharge stages of the collation apparatus 2. A display 311 displays information for placing paper in the printing apparatus 3. As in the display 302 in FIG. 13, when moving a paper set from the collation apparatus 2 to the printing apparatus 3, names of the respective discharge trays of the collation apparatus 2 are displayed in the leftmost first column. When not a paper set, but a single paper type is to be placed as-is in a paper feed tray of the printing apparatus, display is performed with this column remaining empty. That is, in the example in FIG. 14, display is performed indicating that only the paper set in the first column will be transported from the collation apparatus to the printing apparatus, and the paper in the second to fourth columns will be directly placed in paper feed trays of the printing apparatus. A display 303 is a display for checking the respective paper feed stages of the printing apparatus 3. A display 312 displays details of paper information. When not a paper set to be moved from the collation apparatus 2 to the printing apparatus 3, same as the display 203 in FIG. 12, the user checks the paper to be placed using the display 312. A display 313 displays a preview of the paper front and back. When not a paper set to be moved from the collation apparatus 2 to the printing apparatus 3, same as the display 204 in FIG. 12, the user checks the paper front and back using the display 313. In the present embodiment, as shown in FIG. 14, collation processing using the collation apparatus 2 is only performed on the paper set having the ID “100” shown in FIG. 7. Other paper sets are directly placed in the printing apparatus 3 without using the collation apparatus 2.

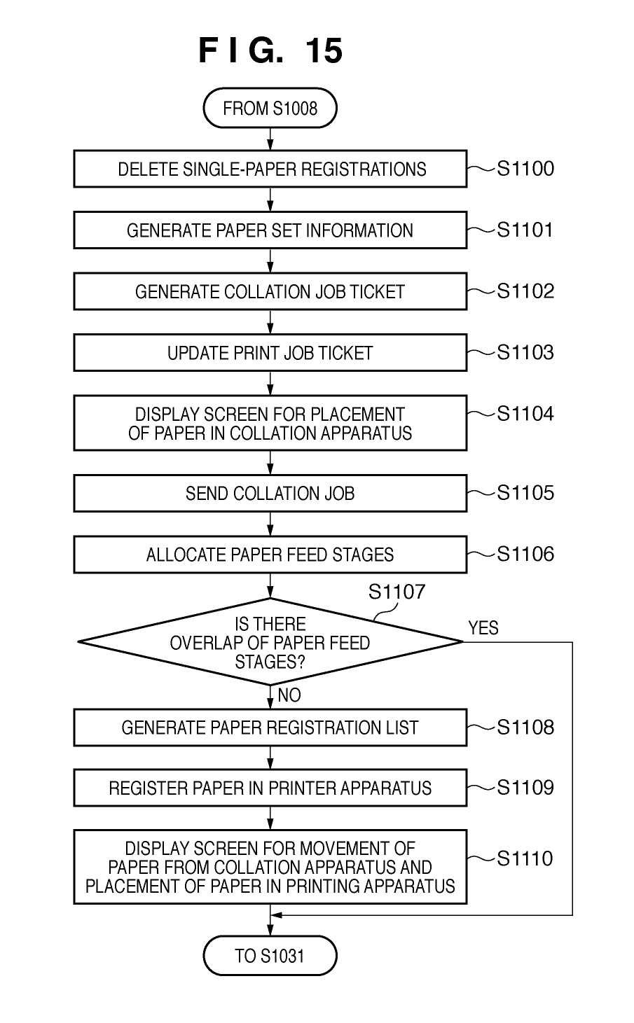

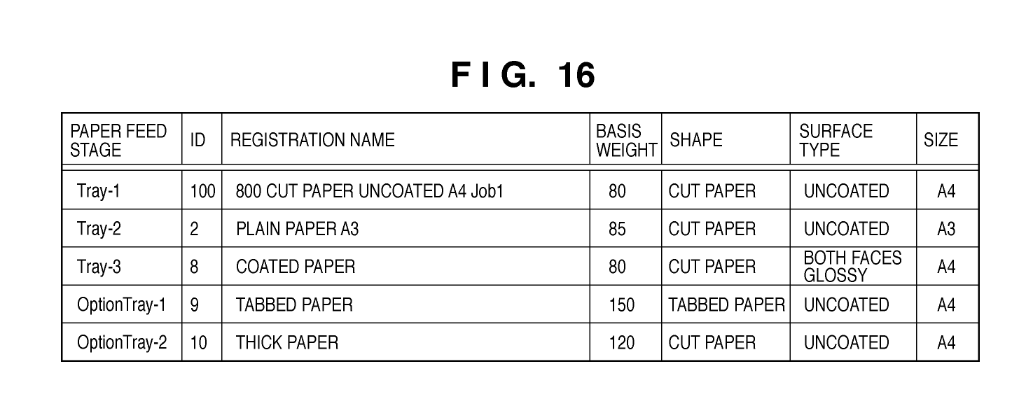

FIG. 15 is a flowchart that shows the sequence of processing of a print job in the present embodiment. Note that FIG. 15 shows only differences from FIGS. 8A and 8B. The flowchart shown in FIG. 15 shows processing in the present embodiment subsequent to S1008. First, when judged in S1008 that there are no paper types that have not been classified in a paper set, processing advances to S1100.

In S1100, the paper set generation unit 19, from the results of paper type classification into paper sets, deletes paper sets defined with only a single paper type. Then, in S1101, the paper set generation unit 19 generates paper set information with only paper sets registered with a plurality of paper types. For example, in the example shown in FIG. 5, only the paper set having the ID “100” includes a plurality of paper types, and therefore results in paper set information generated in S1101. In S1102, the second job ticket generation unit 17 generates a job ticket for the collation apparatus 2 from the paper set information defined with only a plurality of paper types.

In S1103, the first job ticket generation unit 16, in the print job ticket for the printing apparatus 3, only for descriptions of paper sets in which a plurality of paper types are registered, updates those descriptions as described in Embodiment 1. In S1104, the job generation unit 14 displays the sequence for placing paper in the collation apparatus 2 in a screen. When placement by the operator 7 is completed, in S1105, the job generation unit 14 sends the generated job ticket to the collation apparatus 2.

In S1106, the job generation unit 14, according to the paper feed stage information of the printing apparatus 3 acquired in S1005, allocates to the respective paper feed stages respective paper sets that satisfy the conditions of those paper feed stages. In S1107, a determination is made of whether or not overlap occurred in the allocation of the paper feed stages. When determined that overlap occurred, processing advances to S1031. On the other hand, when determined that overlap did not occur, and all of the paper sets and the paper types were uniquely allocated to the respective paper feed stages of the printing apparatus 3, processing advances to S1108. Furthermore, when allocating paper sets to the respective paper feed stages, with reference to the print face information shown in FIG. 6, a paper set and a direction of paper placement (front-facing or back-facing) are set for each paper feed stage. In S1108, the job generation unit 14 generates paper set registration information to be registered in the printing apparatus 3 as shown in FIG. 16.

In S1109, the job generation unit 14 sends the paper set registration information (see FIG. 16) to the printing apparatus 3 and registers the paper set registration information there. In S1110, the job generation unit 14 displays in a screen a sequence for paper movement from the collation apparatus 2 to the printing apparatus 3, and placement of paper in the printing apparatus 3.

As described above, in the present embodiment, the paper type that is the target of collation processing by the collation apparatus 2 is changed. As a result, because collation processing using the collation apparatus 2 is not performed for a paper set including only a single paper type, it is possible to more effectively utilize the paper feed stages and the discharge stages of the collation apparatus 2 than in Embodiment 1.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-064912, filed Mar. 19, 2010, which is hereby incorporated by reference herein in its entirety.

What is claimed is:

1. An information processing apparatus capable of connection to a collation apparatus capable of collating a plurality of types of paper classified based on at least one parameter, and a printing apparatus that processes a print job to perform printing, the information processing apparatus comprising:
a print job generation unit configured to generate the print job;
an acquisition unit configured to acquire information regarding paper feed stages of the printing apparatus;
a designation unit configured to, when a determination has been made that there are more types of paper to be used in printing of the print job than the number of paper feed stages of the printing apparatus, based on a condition predetermined such that values of the parameter are considered to be the same in a certain range, designate papers having parameter values considered to be the same among the plurality of types of paper as one set;
a collation job generation unit configured to generate a collation job for discharging to one discharge stage of the collation apparatus the one set designated by the designation unit from the plurality of types of paper that have been placed in the respective paper feed stages of the collation apparatus; and
a first control unit configured to send the collation job generated by the collation job generation unit to the collation apparatus.

2. The information processing apparatus according to claim 1,
wherein the information regarding the paper feed stages acquired by the acquisition unit includes at least the number of paper feed stages and a size of paper that can be fed by each paper feed stage.

3. The information processing apparatus according to claim 2, further comprising:
a table generation unit configured to, when the information regarding the paper feed stages has been acquired by the acquisition unit, generate a table in which one paper feed stage of the printing apparatus is associated with the one set designated by the designation unit;
a first display unit configured to display to a user an instruction to place paper in the respective paper feed stages of the collation apparatus according to the collation job generated by the collation job generation unit;
a second display unit configured to display to the user an instruction to place the one set that has been discharged to the respective discharge stages of the collation apparatus in the respective paper feed stages of the printing apparatus according to the table generated by the table generation unit; and
a second control unit configured to send the print job and the table to the printing apparatus, and causes the printing apparatus to execute the print job.

4. The information processing apparatus according to claim 1, wherein the parameter of the paper is a basis weight of the paper.

5. A method for controlling an information processing apparatus capable of connection to a collation apparatus capable of collating a plurality of types of paper classified based on at least one parameter, and a printing apparatus that processes a print job to perform printing, the control method comprising the steps of:
generating the print job;
acquiring information regarding paper feed stages of the printing apparatus;
when a determination has been made that there are more types of paper to be used in printing of the print job than the number of paper feed stages of the printing apparatus, based on a condition predetermined such that values of the parameter are considered to be the same in a certain range, designating papers having parameter values considered to be the same among the plurality of types of paper as one set;
generating a collation job for discharging to one discharge stage of the collation apparatus the one set designated from the plurality of types of paper that have been placed in the respective paper feed stages of the collation apparatus; and
sending the generated collation job to the collation apparatus.

6. A computer-readable storage medium that stores a program for causing a computer, the computer being capable of connection to a collation apparatus capable of collating a plurality of types of paper classified based on at least one parameter and a printing apparatus that processes a print job to perform printing, to function so as to:
generate the print job;
acquire information regarding paper feed stages of the printing apparatus;
when a determination has been made that there are more types of paper to be used in printing of the print job than the number of paper feed stages of the printing apparatus, based on a condition predetermined such that values of the parameter are considered to be the same in a certain range, designate papers having parameter values considered to be the same among the plurality of types of paper as one set;
generate a collation job for discharging to one discharge stage of the collation apparatus the one set designated from the plurality of types of paper that have been placed in the respective paper feed stages of the collation apparatus; and
send the generated collation job to the collation apparatus.
